(19) United States
(12) Patent Application Publication
(10) Pub. No.: US 2024/0412316 A1
(43) Pub. Date: Dec. 12, 2024

(54) Voting Software System

(71) Applicant: Gordon Robert Dye, Dallas, TX (US)

(72) Inventor: Gordon Robert Dye, Dallas, TX (US)

(21) Appl. No.: 18/548,050

(22) PCT Filed: Feb. 27, 2022
(86) PCT No.: PCT/US2022/070854

§ 371 Date: Aug. 25, 2023

Related U.S. Application Data
(60) Provisional application No. 63/154,070, filed on Feb. 26, 2021.

(51) Int. Cl. G06Q 50/26; G06F 21/60

(52) U.S. Cl. CPC G06Q 50/265; G06F 21/602; G06Q 2220/10; G06Q 2230/00

(57) ABSTRACT

The present disclosure provides a means and method of conducting a secure, monitorable and auditable voting process and system providing utility, robustness and integrity to said system whereby voters may interface with a voting system and voting authority and auditors may interface with said voting system and authority to simultaneously provide transparency and security, generally. Specifically, the present system allows ease of voter identification, vote specification, vote and voter security as well as vote casting authentication and verification within an efficient and modifiable voting construct that remains mutable by a voter for a designated period (before election day whereon votes are counted, verifiable by voters and verifying entity for determinable periods beyond vote casting or election day. Moreover, the present system provides for a unique means of insuring system integrity by maintaining separated engines and servers for “mirrored” operations for security maintenance, auditing and monitoring purposes.

### FIELD OF THE INVENTION

The central objectives of the “Accountable Democracy” software engine are to provide assurances to voters (and vote processing managers) that 1) an individual voter's votes are counted and tallied accurately, 2) all participating voters' votes are counted and tallied accurately and 3) no unauthorized votes are included and 4) no authorized votes are excluded in an election authority's tallies. Secondary objectives include the provision of convenient voting well in advance of election day, an opportunity or opportunities for a voter to change their mind for a specific amount of time after placing their vote, voter notification that a vote or votes have been received, provision of an optional receipt showing who an individual voted for, the ability to view their vote online from the time voter's enter their vote until a selectable point in time after the election, ease of recounts, and substantially increased security and reliability. The above objectives are achieved by providing vote tabulation software that is at once equally transparent and secure. While transparent may seem to conflict with secure, this unique system design accomplishes both objectives concurrently.

### BACKGROUND

There are many new software applications currently available and/or being developed and tested that pertain to elections, including voter registration, the voting process and various monitoring functions. Several important voting aspects are addressed by such software that will encourage and support participation in the voting process by the voting public. The present application program interface (API) is utilized by such applications to perform ballot storage and tabulation while providing a seamless, ergonomic user interface for facilitating many aspects of the voting process. The present invention, system and method-of-use's role is providing back-end support for such applications that is transparent, immutable, unhackable (i.e., uneditable), and auditable, while providing continuous voter access to submitted ballots.

Invote, powered by Scytl, describes a current state of the art of voting systems being implemented and the security issues addressed by each. The Scytl system is a noted addition to the voting software industry in terms of privacy and security. However, it is considerably less transparent and therefore provides less utility than the presented Accountable Democracy design.

In the Scytl system, the public cannot directly verify the integrity of the Scytl system (i.e., that the system is secure and not being hacked) after ballots are accepted by the tallying server. While the Scytl system can confirm that voter's ballots have been accepted, once a voter's ballot has been transferred to the counting server, digital (confirmational) signatures are removed and the ballot connection to the voter, and the voter registration system, is irretrievably lost when all data is encrypted and placed in a digital ballot box. This ballot box is “mixed” and “shuffled” so individual voters cannot be tethered to a ballot. Manifestly, additional (fictitious) ballots could enter the system undetected thus diluting or overwhelming legitimate votes, thereby creating “electronic” ballot box stuffing where no continuous accountability exists between ballots cast and voters. Too, if malevolent entities obtain the decryption keys, ballots could be modified and election results could be changed-all resulting from the lack of a continuous ability to trace from individual voters to their ballots, making the system “unauditable”. Whereas the present invention efficiently involves individual voters in the process of monitoring the system, the Scytl system contains a fatal flaw in that it does not have the capability or capacity to equip the electorate with the power to continuously track and observe their own votes.

### SUMMARY

The present Accountable Democracy design is an order of magnitude more transparent than present systems in that 1) the voter never loses direct access to his or her ballot and 2) the present system uses a different cryptographic method to protect ballots, enabling them to remain unencrypted and readable by vote tallying entities. The ballot file can be made public after election day, and the actual votes are easily read and counted by any competent computer specialist. This public accounting occurs in addition to individual ballot verification by citizens, and serves as a secondary layer of accountability, transparency, and verification of integrity across the system. Succinctly, the present system and invention allows for security (1) from the voter upward (through 1:1 ballot tethering and unbroken voter/ballot connection) and (2) from the top downward (tabulation system) through public source code availability with transparent continuous monitoring of elections.

Furthermore, in the presently described system, voters have the ability to access their ballots for recasting while remaining anonymous to the system at large. The software can be peer reviewed and the programs ‘in use’ may be publicly policed and monitored throughout the election process through the use of special encryption technology in addition to public and private access to hash values.

Patently, there are many considerations involved in the use of online voting systems. One resource that comprehensively describes such considerations is The Electoral Knowledge Network. This resource discusses several types of security issues and many, if not all, of the issues that pertain to providing to the citizenry online voting and monitoring. However, many of the problematic situations addressed by this discussion simply don't exist in the Accountable Democracy system. For example, there are no vote tallies stored anywhere in the system, so there are no tallies to be manipulated or tampered with. And because the ballot connection to actual voters and voter registrations is maintained, the addition of fictitious ballots or any removal of ballots is easily monitored, audited and detectable. What is more, in the present system, the voting process is decompressed and takes place at an identifiably more measured pace well before election day which distributes data in more consumable quantities for monitoring and security. This encourages voter participation and allows any anomalies to be discovered and corrected in a timely, unhurried manner engendering integrity within the system, reliance upon the election system, and, most importantly, increased voter/consumer satisfaction-all parlaying into greater voter participation and true representation of the whole population.

Last but not least, Microsoft has produced a set of open-source computer programs that implement many of the features in the Scytl system. This provides a comprehensive approach to using electronic ballots along with paper ballots which constitutes a monumental step forward in vote tallying technology. Unfortunately, many of the existing points of election vulnerability are preserved. These points are addressed herein.

Additionally, Election Guard® uses a sophisticated method of encrypting ballots that allows them to be tallied while they remain in encrypted form. Unfortunately, again, this is a substantial step backward when it comes to voter trust. Making ballots unreadable except to the chosen few is expressly the area people distrust about any form of electronic vote processing and is ripe for manipulation and perversion.

In contrast to the Accountable Democracy method, in Election Guard®
1. If a hacker puts in place a rendition of the software that acts like an unmodified version, but alters ballots selectively during the recording process, this action would occur undetected. In essence it would be acting as an imposter. Furthermore, because Election Guard® is open source it would be relatively easy to create such a program. There is no way, in Election Guard® to continuously assure that the software is in fact being used unmodified.
2. The voter has no way to let the system subsequently inform the voter who she or he voted for. So, once again, similar to encryption (above), the technology is saying “just trust me.”
3. Since (1) ballots are not continuously traceable to voter registration data, (2) many registered voters do not vote, and (3) ballots are all encrypted, it would not be difficult for malware to add ballots to the mix of a legitimate voting pool without detection or auditability where the system would “see” these ballots as simply additional votes cast.
4. The most important vulnerability of Election Guard® is that it is designed to support paper ballots, ostensibly to reassure voters that recounts are possible. But in fact, that opens the door to several security vulnerabilities. By geographically decentralizing voting with paper ballots that occurs all on a single day (i.e., the manner in which voting is conducted now), it is not possible to prevent significant fraudulent activity at numerous locations or breaches at specific tolling stations (or even booths within stations).

The Accountable Democracy design eliminates many existing points of vulnerability rather than trying to control them, regulate them or enhance or negate their performance.

As an aside, if an election authority wishes to print hardcopy (paper ballot) backup to the electronic system on election day, that capability may also be provided initially, to bolster confidence in the system and comfort for those who totally mistrust computer technology. This capability may remain as a legacy function or be removed all together.

In essence, Accountable Democracy is a backend system that fundamentally changes the way voting records are entered, received, managed, monitored, secured, stored, tabulated and verified. It strongly assures anonymity and security while providing voters access to their own ballots for security and verification purposes as well as for purposes of amending.

Existing voting applications assist with registering votes wherein ballots are separated from voters (via paper ballot deposits), leaving the door open for undetected vote alteration and fabrication as well as vote subtractions and additions. Further, the possibility exists for tabulation errors, both intentional and unintentional, whereby anomalies and inconsistencies may occur as a result of using paper ballots, through human error or intention. Hundreds, and in some cases thousands, of individual tallies are used by traditional election systems. Voting machines, voting centers, counties, States and Federal voting authorities all accumulate and count votes (e.g., tallies). The Accountable Democracy System eliminates fraud and abuse by NOT depending on the manner in which votes are tallied, nor on tallies themselves. Its focus is upon the integrity of the ballot file and the election software in use, and little else.

Previous patents and electronic voting systems, both foreign and domestic, focus on outmoded systems choosing certain historically defined features (ex. untraceability of paper ballots or digital representations of same) over electronic data transactions which evidence convenience, provide voter authentication, expression security, and voter anonymity secured via modern uses of data capture, data processing, data storage, secure communications and cryptographic technology. While inventor recognizes the utility of such applications, these antiquated systems suffer from multiple infirmities fundamentally characterized by tabulators separating ballots (i.e., data) from their originators—the voters—and dependence upon tallies collected and counted at many dispersed locations. Ostensibly these endeavors attempt to insure voter anonymity, but at a cost of loss of transparency, ongoing weakness in authentication, security, and integrity—all cornerstones of a healthy democracy. Prior art heretofore expressly does not focus on:
1. Transparency of the software source code in a verifiable manner before, during and after the election process.
2. Ongoing ballot control and verifiability by providing voters with the ability to “view” or change their ballots over time.
3. Voter notification by independently notifying voters that they have voted. This mitigates opportunity for other people to usurp a voter's right to vote.
4. Methods of discovery of and recovery from media failure or intentional ballot alteration or forgery.
5. Public inspection of the final ballot file.

As is evidenced above, prior inventors focus more on one-time authentication, which, while justified and legitimate, only serves to complement the novel features of the present invention. The fact remains that voter authentication and verification must be vigorously supported as a corollary to the present invention, whereby, once voting occurs, access remains open to each voter.

Presently, no notice is given to voters confirming votes and ballots are no longer accessible to voters. As a result, the voter must be verified at the moment that the voter accesses the ballot and just before casting a vote or votes and at no other time in the current process. In stark contrast, the present invention allows for authentication and verification throughout the voting process and most pointedly well after a vote is cast.

The focus of the present invention specifically is on what happens to the ballot once the voter has expressed their preferences (voted), and from that time forward until well after the election. The current invention permits voters to not only authenticate their identity and authority to vote (by verifying their registration), but also verify that their vote was both received and recorded correctly (e.g., not omitted, changed, fabricated or duplicated), all with an ability to change their mind and recast a vote, which may differ from their previous vote or votes. The present system also eliminates the possibility of altering vote tallies because no tallies are stored in the present system except transitorily and momentarily. And computed vote tallies can be verified externally by offloading the ballot file to the public domain for monitoring, verification, accuracy and security purposes. In doing so the present invention provides voter anonymity from public inspection while concurrently providing ongoing ballot visibility and accessibility to individual voters' votes for ballot measures, primaries, run-offs, referendums, special elections and general elections, among others.

However, a more detailed understanding of the invention will be obtained from the following description when taken in connection with the accompanying tables throughout. Yet, these embodiments should not be construed as limitations on the scope of any embodiment, but moreover as examples of various embodiments thereof. The invention itself is configurable and modifiable to many other variations possible within this application and provided by the teachings of the various embodiments as will be appreciated those having skill in the art. Thus, the scope should be determined by the appended claims and their equivalents, as interpreted in light of the present specification, and not merely by the examples given.

### BRIEF DESCRIPTION OF THE DRAWINGS

While the novel features and method of use of the application are set forth above, the application itself, as well as a preferred mode of use, and advantages thereof, will best be understood by referring to the following detailed description when read in conjunction with the accompanying drawings in view of the appended claims, wherein:

FIG. 1 depicts an overview of the current process for conducting voting;

FIG. 2 depicts an overview of the new process for conducting voting.

FIG. 3 illustrates the present Accountable Democracy Engine invention;

FIG. 4 is the present invention providing a basis for voter identity protection;

FIG. 5 displays one preferred embodiment representing operations of a ‘Main Server’.

And while the invention itself and method of use are amendable to various modifications and alternative configurations, specific embodiments thereof have been shown by way of example in the drawings and are herein described in adequate detail to teach those having skill in the art how to make and practice the same. It should, however, be understood that the above description and preferred embodiments disclosed, are not intended to limit the invention to the particular embodiment disclosed, but on the contrary, the invention disclosure is intended to cover all modifications, alternatives and equivalents falling within the spirit and scope of the invention as defined within the claim's broadest reasonable interpretation consistent with the specification.

### DETAILED DESCRIPTION

For a more complete understanding of the present disclosure, reference is made to the following detailed description. Although the present disclosure is described in detail with exemplary embodiments, the present disclosure is not intended to be limited to the specific embodiments set forth herein. It is understood that various omissions and substitutions of equivalents are contemplated by inventor as circumstances may suggest or render expedient, and such modifications, amendments and variations are intended to cover the application or its implementation without departing from the spirit or scope of the present disclosure.

Further, it should be understood that no limitation in the scope of the disclosure is hereby intended and further applications of the principles of the disclosure, as illustrated therein, are contemplated as would occur to one skilled in the art to which the disclosure relates. Also, it is to be understood that the phraseology and terminology used herein is for the purpose of description and should not be regarded as limiting. Furthermore, the appearances of such phrases and terms, at various places provided herein, are not necessarily all referring to the same embodiment. The terms “a” and “an” herein do not denote a limitation of quantity, but rather denote the presence of at least one of the referenced items. Finally, the best mode or modes of implementing and practicing the present invention are disclosed herewith and those details necessarily for carting out the operation of the presented voting system are provided as would allow one having skill in the art to make and practice the same.

The present disclosure provides a means and method of conducting a voting process, providing viability, robustness and verifiability to said system whereby voters and auditors may interface with a voting system and voting authority to simultaneously provide accuracy, transparency and security. What is more, the present system allows ease of voter identification and vote preference recording, as well as vote casting (i.e., freezing) within an efficient and modifiable voting construct that remains mutable by a voter (for a designated period before vote counting) and verifiable by a verifying entity (for determinable periods beyond vote casting or election day). Finally, the present system provides for a unique means of insuring system the integrity of the system by reporting hash values and maintaining separated engines and servers for “mirrored” operations for auditing and monitoring purposes. As provided below, this process originates with the election procedure itself.

### Election Procedure

Existing election procedures require voters to register in a country, state, region, principality, district (or other election authority) voter registration system. This will continue to be a requirement.

Each voter is assigned (1) a public voter number (PVN) and (2) a secret voter number (SVN). Secret voter numbers are not exposed or released to anyone. SVNs are also unknown to their assigned designates (the voters) and PVNs are openly available and used to remove ambiguities of and potential discrepancies between and among names. This concept is evidenced and explained in greater detail below (See specifically Secret Number Obscurity).

For the purposes of the present invention, voting takes place prior to “election day.” Election day is defined as a day where all ballot votes are required to have been received and collected by a voting authority. Tallying may be conducted, and results made available either on election day or a subsequent day. The election authority, in concert with state and local laws and officials, determines when the election will commence and when the ballots will be counted. Typically, the time allotted is six weeks, but may be less or more depending on each state's laws and on the type of election (e.g., primary, runoff and the like).

When an individual's voting operation is performed, the voter is informed that a receipt, digital or paper, is made available to each voter. If a voter opts to receive a receipt, a digital or printed receipt is issued electronically or in paper form evidencing who a voter voted for, as well as the voter's individual public voter number (PVN). Yet, each receipt does not contain a voter's identifying information (e.g., name, address etc.) or a date on which a ballet was cast. Only a voter's PVN is evidenced, to prevent the inappropriate use of voter information or use of the contents of a completed ballot. In the present example, voting is accomplished at a government provided voting center or, alternatively, via the Internet. Printed receipts also identify the voter interface mechanism (e.g., via a voting center, through a phone application, or on a computer) used to record the vote.

When a vote or votes are processed by the present invention, each vote or votes (by a single voter) create a “ballot record” (BR) in an Accountable Democracy Engine (ADE) with the same information that is presented on the receipt, except instead of the public voter number (PVN) it contains the voter's secret number (SVN) encrypted (see also Secret Number Obscurity below).

The Accountable Democracy Engine will provide an application program interface (API) for online voting applications and election authority voting machines used to authorize and record votes. ADE voter authorization will use the election authority system to obtain registered credentials (driver's license or state ID, etc.) and authorization codes, and will forward them to third party end user voting applications for voter identity verification. The ADE will retain and keep private the (encrypted) voter secret numbers while it authorizes the voting process for the voter public number. The Engine will also include an API (API 2) for election authorities to use for inquiry.

The third-party end-user application will query the ADE providing voter identifying search information and the ADE will search for the applicable voter registration, and act as an arbitrator in the voter identification process. Once a voter is properly matched to a voter registration the ADE will provide a ballot structure and PVN to the application in the form of a ballot template to be completed and returned.

User interface (client) software that facilitates the actual voting process (and optionally provides a receipt) may or may not be connected to the Internet at the time the vote is cast. Voting authorization may be attained offline by storing a local copy of the public voter registration file (excluding secret voter numbers). A temporary ballot can then be created offline and later submitted by the application to the Accountable Democracy Engine (ADE). If the voter has not already voted when the ballot is later submitted to the Engine, it goes through the same election authority verification and election authority notification process that would take place had the user voted online. If the voter has previously voted and someone attempts to register a vote or votes in the ADE, the vote is blocked and the actual authorized voter is notified that an unsuccessful attempt to vote has been made using their credentials. The time and place or mechanism of the unauthorized attempt will be documented.

When the Accountable Democracy Engine processes a ballot, it creates a ballot record internally, and the voter is notified that a voter has voted (via text, email, recorded phone message and/or by postal mail). At that time the election authority voter registration record is updated to show the date, time and voting facility used to record the vote. The engine, of course, knows if the voter has voted because said engine has access to all of the ballots.

Once a ballot record is created, the voter is free to inspect and interrogate his or her own ballot record online (a service offered by the election authority using an ADE API 2) to assure herself or himself that their vote or votes were properly recorded. If there is a discrepancy between the vote or votes cast and/or the original printed receipt, said voter can place an objection with the voting authority. At any point thereafter during and after an election, and for as long as the election authority deems appropriate, or a time period legally allowed, a voter can print another ballot receipt with the full ballot information, but not the date or the particulars of the mechanism used to vote.

Once a vote is cast and a ballot record is created, the voter has a set time (determined by the election authority-typically no less than 72 hours) to cancel their vote if they so desire. In each election there will be a deadline (typically 24 hours before election day) after which cancellations are not allowed. If a voter cancels their vote or votes they are free to vote again. A limit can be placed on the number of revotes allowed.

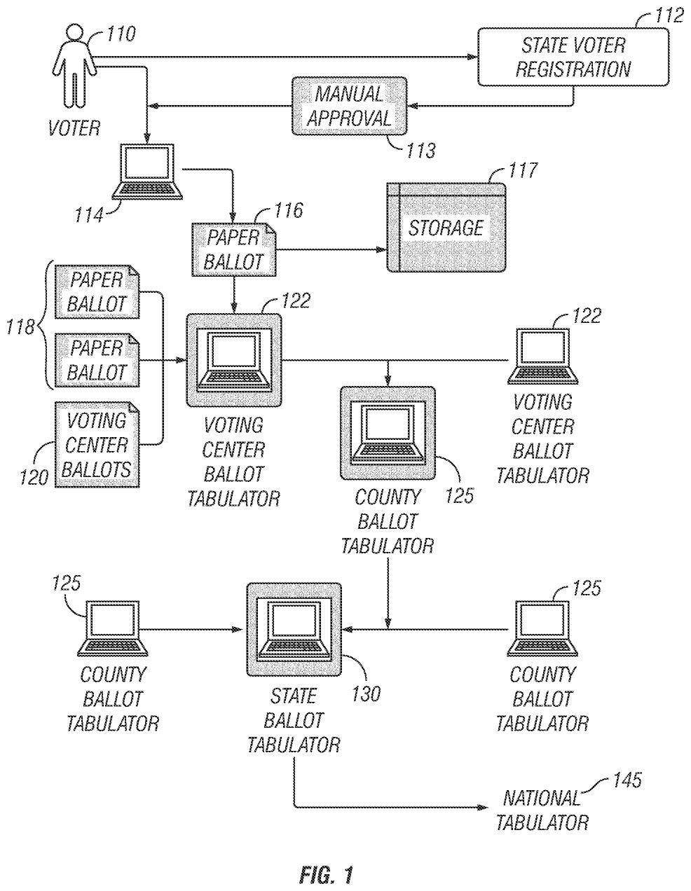

FIG. 1 shows an overview of the current process and voting procedure by which elections are currently conducted whereby selected potential security weak points in the data flow are identified. As illustrated, voter 110 may vote through a state provided voting machine 114 which produces a paper ballot 116. Pointedly, intermediary, physical or manual approval 113 is necessitated wherein the state voter registration printed voter rolls are utilized. Once a vote is cast, a voter 110 has thereby generated a paper ballot 116, which is gathered in addition to other voter's paper ballots 118, collectively voting center ballots 120, are then tabulated via a voting center ballot tabulator 122, Voter 110 paper ballot 116 is then stored for later inspection in a segregated storage 117. Voting center ballot tabulators 122 may reach any number (n) necessary to service each voting center. Cast votes may then be gathered in a county 125, state 130 and national level 145 tabulator for final tabulation for determining election or elections outcome. Potential points of manipulation, intervention, or error (consequential inflection points), shown in shaded areas, exist most clearly at manual approval 113, individual voter paper ballot 116, storage 117, cumulative ballots 118, 120, at county ballot tabulators 125, state ballot tabulators 130 and, potentially, national tabulators 145, where outside interjection or internal manipulation of the system of vote tabulation is most vulnerable.

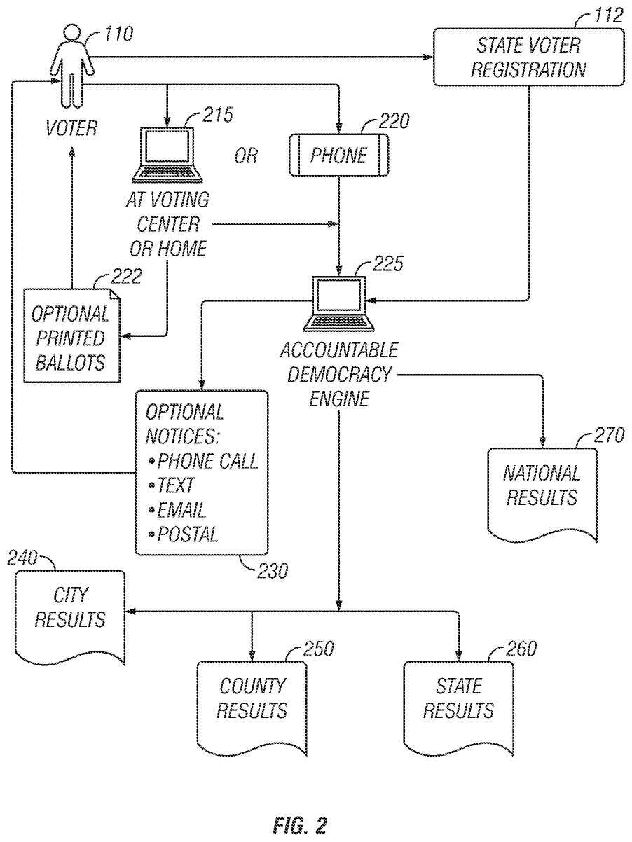

Alternatively, in FIG. 2, data flow is depicted using this the present invention via the new and novel voting procedure as described herein. Voter 110 may cast his or her vote as is customarily achieved through a state provided voting terminal 215 or other computerized input such as a home computer 215 which, under the present disclosure, may also be accomplished by smartphone 220. If the voter 110 utilizes a voting center or home computer 215, voter 110 may opt for a printed ballot 222 as confirmation of vote or votes cast. Regardless of method, though, voting is routed through the present Accountable Democracy Engine (ADE) 225, described in detail herein, to ensure proper vote receipt in the secure voting system that is the present invention. From there the ADE 225 will inform the voter 110 of receipt of ballot by providing voter 110 a notice or notices via phone, text, email, US mail 230, or a combination thereof. Upon completion of all voting, the ADE 225 shall provide cumulative voter ballots cast in the form of tabulated city results 240, county results 250, state results 260, and state totals of national results 270, or a combination thereof.

Note that multiple ADEs 225 representing multiple states will collaborate (not shown) to share state totals to report national results 270. Since adding state totals among multiple states is relatively trivial, it is not necessary to provide a separate national consolidation center. However, communication between state ADEs does occur via the Internet. Published ballot files are not combined across states. National reports will be the same for every state ADE in the network.

### Ballot Record Accumulation

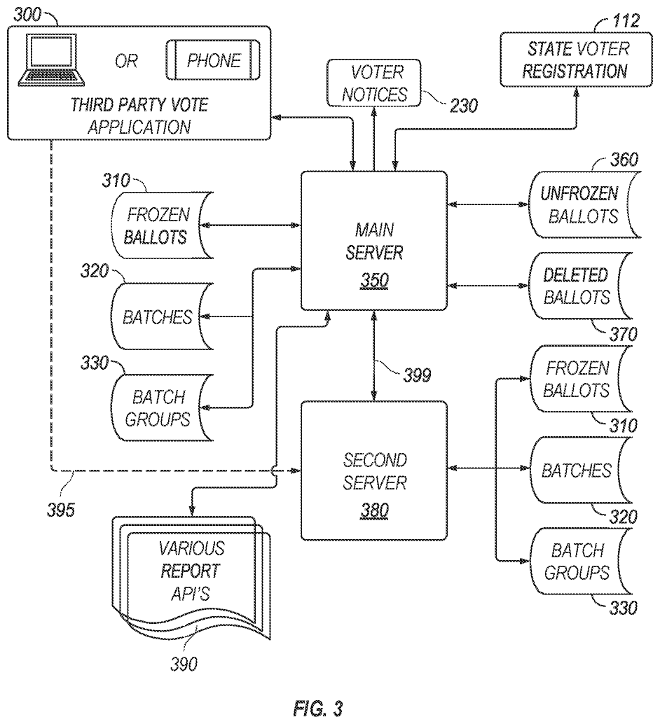

FIG. 3 further illustrates the above ADE in more detail wherein voting procedures may occur on any computerized means of casting votes, at a voting center, via home computer or smart phone application 300 wherein ballot records are assigned a sequential number as a part of their structure which may be used to subsequently access them records. As noted, voters 110, voting by computer or smartphone 300 shall cast votes directly to the ADE 225 via the primary or main server 350. Also, voter 110 may receive notices as described in FIG. 2 230. Ballot records are frozen, noted here as frozen ballots 310, after 72 hours (or another specified period as defined above) from their time of creation. As frozen ballots 310 accumulate, they are batched in batches 320. Ballot number lists (batches 320) are stored in a batch file wherein batch size may be established during system setup and each batch is issued a 256 byte SHA or other hash value and a batch number. The hash value pertains to all the ballot data in the batch including the encrypted SVNs.

### Batch Record Content:

ballot number A
ballot number B
ballot number C
ballot number [(N)ₙ]
hash value of ballot data
batch number

The ballot data itself (other than SVNs) is maintained in an unencrypted state. Votes for competing candidates are expressed via a binary candidate numbering system. For example, if four people are running for a particular office they will be numbered internally 1, 2, 4 and 8. Instead of having a dedicated checkbox internally, they will have one candidate number per open office. This assures that if any ballots are changed, a dramatic change will occur in the batch SHA hash value. Possible alternatives to that are 1) express the candidate numbers for a position using alphabetic values or 2) numbers expressed using alphabetic characters.

Batches 320 themselves are grouped (listed) in batch group records (batch groups 330) which are stored in a batch group file, and each batch group 330 is issued a sequential number and a hash value that pertains to all the batch records in the group. There are two types of group records: 1) records that pertain to batches 320, and 2) records that pertain to batch groups 330. Batch group 330 records are assigned level numbers so that groups can be “grouped” (i.e., arranged) hierarchically. The first level (level 1) lists batch records. Level 2 and above records list (and hash) group records in the level just below them.

Ballots stored in the unfrozen ballot 360 file are protected by individual ballot hash values stored in a separate unfrozen hash value file (not shown).

In summary, there exists an election authority managed voter registration 112 file, an unfrozen ballot 360 file, a frozen ballot 310 file, a batch 320 file, a batch group 330 file, and a deleted ballot 370 file. In addition, the software may exist on two “mirrored” servers, operating in tandem, whereby a secondary server 380 verifies the processing of the primary or main server 350, effectuating redundancy and aiding in monitoring and verification activities. Moreover, this second server 380 may run in parallel or tandem with the main server 350, but on another or different cloud service. Too, each server, or plurality of servers, may function to generate one or more reports 390 utilizable to allow for system monitoring, verification, security or a combination thereof. Too, voters 110, voting by computer or smartphone 300, may optionally communicate with both main server 350 and second server 380 via a secondary communication pathway 395 in addition to the communication occurring between main server 350 and second server 380 as displayed in communication 399.

It is further in contemplation of inventor that a third ADE server (not shown), running in tandem or parallel to an existing server or servers, may be another system managed by an entity other than a state or federally managed entity (e.g., a privately-controlled, publicly controlled or an otherwise non-state sponsored concern), or via a partnership between a state/federally managed system and a private concern, wherein a system of checks and balances is created to add oversight, monitoring and/or legitimacy to the present system.

Security and Transparency

### DEFINITION OF TERMS

Hash Value—A value that is an accumulation of bits from a data stream in a manner that uses a mathematical algorithm such as SHA-256 to produce a fixed length result. This is also referred to as a “hash total” or simply a “hash”.
Asymmetric Encryption—A type of encryption that uses two different keys. Each key can decrypt what the other one encrypts. Often these are referred to as public and private keys. However as used by the present invention no keys are made available to the public. Each communication channel uses Transport Layer Security which creates unique key pairs for each connection.

It is inventor's intention to make the source code of the main server for the Accountable Democracy Engine (ADE), including the operating system, available for public inspection and licensing of said system for use to conduct elections. Here we describe how we assure the public that the software in use is the exact software that we release to the public.

The ADE 225 is designed to run concurrently on two to a plurality of dedicated servers 350, 380 (typically provided by competing cloud services) and the engine includes its own operating system (OS). Initially this may be a scaled down Linux or BSD type of OS. During bootup the current program sets all unused memory to zero and upon completion of bootup it establishes a hash value of the OS executable code and another hash value of the application executables.

At random intervals the present system recalculates and compares these program hash values to those established at bootup to assure that no programs have changed. It also periodically revalidates (checks) all file (table) hash values to ensure the integrity of the data. The memory allocation routines used by the software zero out memory when relinquishing it.

The software, also upon demand or instruction, recalculates the hash value of all executables that process ballot 310, batches 320 and batch group 330 records and provides them to client and government applications through the APIs. All source code in the ADE 225 main server 350 is publicly available for independent inspection and compilation for executable code hash verification purposes (thus facilitating both state management and public oversight). This includes source and object code for calculating the hash values. This will provide heightened scrutiny through open inspection of methods and processes, but will not expose voter identification or actual ballot results during the election.

It is expected that during elections the low order 8 characters of these critical hash values will be published in the media and/or made available on a publicly accessible web site and these values will be dynamically obtained from the engine and displayed on client user interfaces when voting.

### Second Server Functionality

The second server 380 runs in “slave” mode and essentially duplicates all ballot accounting processes performed by the main server 350. The main server 350 forwards a copy of all inbound data traffic to the second server 380. The second server 380 can also accept input directly from client applications for verification purposes (see pathway 395). Periodically, the top group hash values produced by the two servers 350, 380 are compared to assure both are functioning alike. An optional third server (not shown), or plurality of servers (not shown), can be attached to the configuration, for greater security and to identify the correct ballot information in the event of a discrepancy between the main 350 and second 380 servers, And the third server (not shown) can be anywhere on the Internet such as at an auditor's facility.

In the event a main server 350 is compromised or disabled, a change of roles can take place by 1) placing the main server 350 in a bi-directional forward-only mode or rerouting the network traffic to and from the second server, and 2) switching the second server 380 to standalone mode. Once the main server 350 is either secured or repaired, this server may be used as a secondary server or reclassified as the primary server, as conditions dictate, acting as a mirror server or validation server.

Several of the ancillary functions of the main server 350 are not provided in stand-alone mode, but it does include all ballot processing and group record processing, voter notification, and voter inquiry support. The files created and maintained by the second server in standalone mode are identical to those on the main server.

As ballots are grouped hierarchically, all levels can be compared between servers by comparing the single hash value at the top level of each group file. If a discrepancy occurs, the software can quickly identify the ballot groups and actual ballots that differ between the two servers 350, 380, or plurality of servers by examining the group hashes down to the lowest hash discrepancy, and then comparing actual ballot records within each group whose keys do not match. The second server therefore provides a monitoring function in order to detect and pinpoint discrepancies existing within group hashes down to an individual batch level. Once an erroneous batch is identified, other means are used to identify discrepancies within the batch (e.g., comparison to backups and mirror data).

The software therefore can quickly identify any erroneously recorded ballots (i.e., ballots that differ between duplicate sets of ballot data) and report specific discrepancies within those ballots. By creating progressive sets of backups in a third location, it is fairly easy to see what the original values were in those ballots. Of course, with the amount of protection these ballots have, it would be very rare for ballots to be changed, but media errors cannot be ruled out since they do occasionally occur.

### Exception Processing

At specified or random intervals an inspector program is uploaded into the present system from an Accountable Democracy (or election auditor) server (not shown) which then uses a dynamic algorithm to modify its own hash after startup. The program is not aware what its own hash is or will be, but the Accountable Democracy external server does have access to this information. The inspector program audits the environment and reports its own hash value along with its findings with reference to all executable code hash values and a map of dynamically allocated memory.

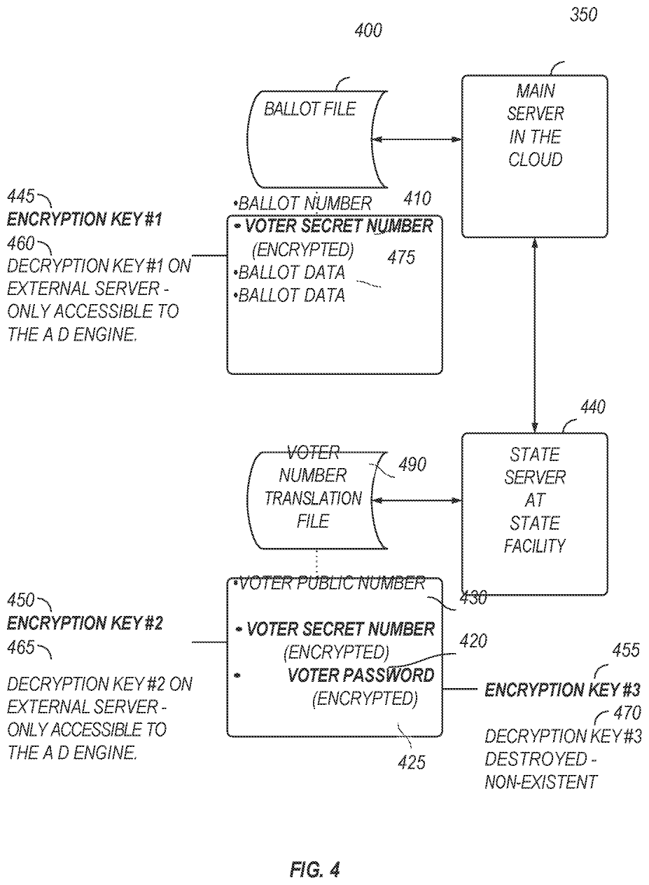

As in FIGS. 3 and 4, upon request from the election authority or other monitoring institution, a complete audit of the ballot files 400 (i.e., frozen ballot 310 in FIG. 3) may be performed by having the election authority send a list of all (encrypted) secret voter numbers 420 of voters who have voted to the ADE 225. The ADE 225 then will find and track all ballots associated with the provided list. Any abnormalities, missing or excess ballots, or a combination thereof, will then be reported.

Periodically the system will audit the ballot file 310/400, batches 320 and batch group 330 files by recomputing all hash values in the batch 320 and batch group 330 files and matching the results to stored values, checking to be sure each ballot number 410 appears in one and only one batch 320, and checking to be sure there are no duplicate secret voter numbers 475 in ballots data 400.

Before publishing the final ballot file 400 the secret voter numbers 475 are re-encrypted with new keys, just in case the internal encryption key has been malevolently obtained. At that time all ascending hash values are recomputed. At the time the final ballot file is released, the corresponding batch file will accompany it.

### Table Driven Electronic Ballot Structure

A broad range of possible ballot definitions and voting methods are supported including primaries, elections, races, legal measures, referendums, proposals, and the like. Moreover, the system is designed to be multi-lingual and is capable of supporting a multitude of visual cues and optical aids.

### Election Authority Dashboard

The ADE 225 can report to election authorities geographical statistics concerning the number of voters who voted in each geographical area. This information will also be available to election authorities via their own records of who has voted. No other ballot information will be provided to election authorities prior to issuing a final tabulation.

### Secret Number Obscurity (Voter Identity Protection)

On State (election authority) servers, when a voter is registered, he or she is provided an account and is assigned (1) a public voter number 430 and (2) a secret voter number 420. The voter secret number 420 is provided to the election authority (state server at state facility 440) by an ADE 225 utility function in asymmetrically encrypted form, and the-unencrypted voter-specific number 420, is not exposed to anyone. Expressly, the election authority is not provided with either encryption keys 445, 450, 455 or decryption keys 460, 465, 470. The unencrypted secret voter number 420 may contain characters other than digits including but not limited to upper and lower case letters, and printable special characters.

When the ADE 225 receives an encrypted voter secret number 420 from the election authority 440 sever, the ADE 225 immediately decrypts this number and re-encrypts it, using a different key for storage in a ballot. The decryption key the ballot voter secret numbers 460 and election authority voter encrypted numbers 465 are stored only on an external Accountable Democracy server (in encrypted form—not shown) and in ADE 225 memory.

In summary, election authorities 440 have no access to voter secret number 420 encryption keys, 450, or decryption keys, 465, and the ADE 225 has no access to ballot voter secret number decryption keys 460 and 465, except when they are provided from an external source for ballot voter number processing. When voting occurs, public voter numbers 430 are used for coordination between the user application, the ADE 225, and election authority servers 440. Later, When the voter accesses their ballot though the election authority system, their encrypted secret number 420 is sent to the ADE 225 which translates it to the second encrypted version 475 and searches for the associated ballot record number. Election authorities utilize an intermediary voter number translation file 490, as opposed to accessing voter secret numbers 420 directly. Voter passwords 425 are encrypted, see encryption key #3 455, wherein whereas decryption key #3 470 is destroyed (non-existent).

### Technical Considerations

Today's computer programming tools are very broad based. There are many ways to implement this design. From a technical angle the keys implementing the present system are:
1. Open-source operating systems;
2. Publicly available program language compilers and source libraries;
3. Publicly available cryptographic techniques for both hashing and using asymmetric keys;
4. The ability of software to self-inspect;
5. The ability of software to be peer reviewed and monitored during an election via the dynamic calculation of program-executable hash values.

In the event an alarm is sounded, due to inconsistences between and among server(s), data, or by voters expressing concern, it is a simple matter to upload fresh inspection software that will confirm the status of each server. Since all ballot handling is centralized for each election authority, there is only one point of data or program aberration that needs to be monitored, and that can be readily assessed.

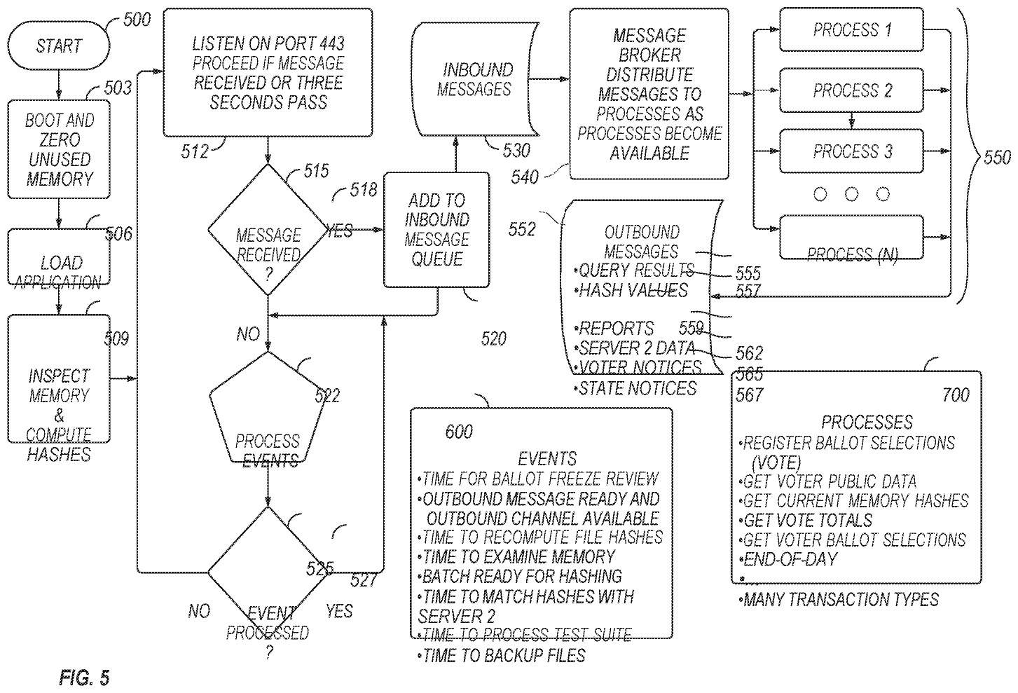

FIG. 5 presents one possible program structure for implementing these described methods. The presented preferred embodiment serves as an example and it is posited as time goes on technology improvements will become available for better implementations. The significant aspects of the design are listed in FIG. 5 and this example is presented to describe one of many possible program structures (a) monitoring and effectuating events 600 including, but not limited to, (1) time for ballot freeze, (2) outbound message ready, (3) outbound channel available, (4) time to recompute file hashes, (5) time to examine memory, (6) time ready for hashing, (7) time to match hashes between main server and second server (or plurality of servers), (8) time to process a test suite, (9) time to backup files, or a combination thereof, and/or (b) conducting specific processes 700, including, but not limited to, (1) registering ballot selections, (2) retrieving public voter data, (3) retrieving current memory hashes, (4) retrieving vote ballot totals, (5) retrieving voter ballot selections, (6) initiating and undertaking EOD functions, among others. By way of example, at program start 500 bootup the current program sets all unused memory to zero 503 and the ADE 225 application loads 506, memory is inspected and hash values are computed 509. Next the ADE 225 main server 350, second server 380, or both, actively monitor for either a message 512 (here over a 3 second time period). If a message is received 515 (indicated as ‘YES’) 518, said message is added to the inbound queue 520. If no message is received 515, but there is an event to be processed 522, that event 525 is processed (followed by ‘YES’ 527) and the system checks for another event. Inbound messages 530 are brokered by message broker 540 to effectuate processes 1, 2, 3 . . . n 550 resulting in outbound messages in the form of (1) query results 555, (2) hash values 557, (3) reports 559, (4) second server data 562, (5) voter notices 565, (6) state notices 567 and the like. Of note, only messages are brokered because events require less processing time so they are processed by an event loop.

### Blockchain Alternatives

Blockchains are generally recognized as secure and immutable. Hence, they make a good ballot storage mechanism. However, the present invention does not utilize blockchain and is superior to blockchain in the following respects:
1. Ballots are at once traceable, anonymous, publicly visible and immutable. In blockchain the ballots are not meaningfully visible to voters. The present invention maximizes transparency which is a core aspect of trustworthiness. When using blockchain, if decipher keys are intentionally or surreptitiously released to the public, then voter identities also become visible.
2. Using blockchain, sophisticated software is required to tally votes and this presents a point of vulnerability to tampering. Anything that cannot be accomplished in plain view, verifiably, is subject to tampering and suspicion. In the present system, the ballot file may be released to the public for inspection, confirmation of integrity, and for recounts.
3. The present invention uses a substantially more efficient storage format than blockchain. By only encrypting secret voter numbers it minimizes storage requirements, and, by properly utilizing cryptographic technology for protection without encryption, the present system makes storage uncomplicated, efficient and fast to identify and isolate data aberrations, whereas blockchain must use extensive redundancy, complicated forms of discrepancy resolution, and substantial computing power and natural energy resources.
4. The use of blockchains is not amenable to voters changing their minds or cancelling out votes that are in dispute. Once a block in a chain is stored in the chain, it is not removable.

### Key Operations

The keys to success (in terms of voter and management confidence) of this type of vote counting and accounting are:
1. The ability of voters to reexamine their ballots thus providing the power to the ultimate user to ensure requisite security that ballots are not changed.
2. The ability of software to self-inspect whereby software has control of its entire operating environment (both the OS and the applications) and can inspect and police its computing environment (as well as itself), and with hashing techniques, quickly determine any aberrations or deviations.
3. The ability to quickly determine whether a discrepancy exists between copies of ballot files and rapidly identify differences.
4. By not storing tallies and retaining only ballots the system utilizes the least amount of data requiring protection. This key aspect, in conjunction with sufficient progressive backups, maximizes efficiency while minimizing vulnerability.
5. The obfuscation of voter secret numbers provides a foundation upon which item 1 above rests. Voter verifiability of ballots in conjunction with anonymity is fundamental to any voting process but is not provided by previous voting methodologies. The present means of protecting the identity of the voter permits exportation of the ballot file (e.g., for public inspection, backup and recounts) without compromising the identity and security of voters.
6. The ability to periodically verify a one-to-one correspondence between the number of voters who voted and the number of countable ballots during the course of an election.

Clearly, the present system displays and is capable of accomplishing the following methods and techniques via certain preferred embodiments: the ability to securely conduct an election over an extended and extendable period of time much greater than a single day (e.g., six weeks), ending before election day, in a manner which facilitates rapid, secure and transparent (publicly observable) tabulation on and after election day, the ability to electronically connect a voter authorization process with an election authority voter registration database, the ability to forward credentialing information from the election authority database to (3^{rd} party) end user voting applications, the ability to immediately electronically notify the election authority database server when a voter has voted, the ability for the voter to anonymously view their ballot online continuously, for as long as the election authority allows, both during and after an election, the ability to prevent any traceback from a digital ballot to the voter who created it while concurrently enabling the voter to observe their ballot, the ability to independently notify each voter that their vote has been received, through a variety of means such as audio, text, email, and postal mail, and the ability for a voter to cancel or change their vote (which restores their voting eligibility) during a specific period of time (suggested 72 hours) after they vote, before their vote becomes frozen (immutable). While other systems may provide a printed receipt at the time of voting (which this system encourages and advances), the present invention supports the ability for the voter to obtain a printed receipt (via the election authority system) at any time after voting, both before and after ballots are tabulated, for as long as the election authority allows, showing who and what they voted for. This receipt is to be undated and show the voter's public number but not their name.

In addition, the present invention and system advances the ability to NOT encrypt digital ballots (except for voter ID numbers) that will eventually be put in the public domain, and to concurrently protect the ballots from alteration by storing batch hash values in a separate file, the ability to support the dynamic display of all or part of the tabulation engine operating system program hash values on end user voting devices, the ability to support the dynamic display of all or part of the tabulation engine application program hash values on end user voting devices and the ability to reencrypt all secret voter numbers stored in ballots before publishing the ballot file publicly.

What is more, the current invention allows for an ADE to: operate on multiple coordinated servers on the same or separate cloud platforms and utilize decryption keys stored only offsite and in ADE dynamic memory for the purpose of decrypting voter secret numbers to:

The present invention also manifests an ability to individually hash total ballots stored in the unfrozen ballot file and to store those hash values in a separate file, the ability to hierarchically group the hash values of ballot batches, providing a top-level summary hash value of all ballots frozen during an election, the ability to use multiple asymmetric encryption keys to hide voter identities such that the encrypted voter numbers stored on election authority servers are different from the encrypted form of those same numbers stored in ballots, the ability to periodically hash all program bits that the tabulation engine operating system is comprised of, the ability to periodically hash all program bits that the tabulation engine application programs are comprised of, the ability for the ADE to zero all unused computer memory during an election, as well as the ability to receive data from a voter user interface application independently at more than one server and to compare those receipts for verification purposes.

What is more, the present invention system and method of use manifests the ability to manage the vote tabulation process with no vote totals stored in the tabulator except during the reporting process (whereby votes are recounted directly from frozen ballots each time they are reported), the ability to randomly send in an inspector program from an offsite facility to inspect the memory content of the ADE servers, the ability to provide a dashboard for election authorities to be run on election authority servers to report how many voters have voted in each fractional area (e.g. county), and the ability to audit the ballot file by finding all ballots associated with voters who have voted according to the voter registration database, and reporting any missing or excess ballots.

This process utilizes two voter numbers, one of them secret, to protect voter identity, to tag votes and tether them to voters while maintaining voter anonymity.

Further the present invention harbors the ability to set the ballot batch size and the batch group size for any given election, to periodically recompute all ballot and batch hash values to validate stored hash values, and the ability to quickly identify which batch or batches have been modified via the hierarchical hash tree in the event of tampering or media failure.

While the foregoing description and drawings represent examples and preferred embodiments of the present invention, it should be understood that various additions, arrangements, combinations and/or substitutions, sequentially or in parallel, may be made herein without departing from the spirit and scope of the present invention as defined in the accompanying claims. In particular, it will be clear to those skilled in the art that the present invention may be embodied in other specific constructs, configurations, with disparate structures, arrangements, proportions, and with other elements, materials, and components, without departing from the spirit or essential characteristics thereof. One skilled in the art will appreciate that the invention may be used with many modifications to construction, arrangement, proportions, materials, and components and otherwise, used in the practice of the invention, which are particularly adapted to specific requirements and operative environments without departing from the principles of the present invention. In addition, features described herein may be used singularly or in combination with other features. The presently disclosed examples are, therefore, to be considered in all respects as illustrative and not restrictive, the scope of the invention being indicated by the appended claims and not strictly limited to the foregoing description.

It will be appreciated by those skilled in the art that changes could be made to the examples provided above without departing from the broad inventive concept described.

1. A method for providing transparent security to a voting system comprising the steps of:
assisting an election authority voter registration and monitoring facility;
implementing a primary voter authorization, vote recording, and vote tabulation and reporting software engine operating on a first server;
assisting a third party an end-user voter application;
said software engine providing a first application program interface (API) to be accessed by said end user application;
said first API used as a resource and repository for the authorization and recording of votes;
said first API used to obtain voter identification information and documents to be
used for voter authentication;
said first API used to obtain the current program and operating system executable
code hash values for public display;
said software engine providing a second API to be accessed by said election authority facility;
said second API used by said engine to request and receive voter credential data to be used for voter authentication;
said second API used to provide said election authority facility unassigned encrypted SVNs for assignment to voters;
said second API used to notify said election authority facility that a voter has voted;
said second API used to enable a voter to observe and print their ballot contents;
said second API used to enable a voter to cancel their ballot while it is unfrozen; said second API used to periodically or at random intervals verify that the
number of countable ballots matches the number of voters who voted and to report any discrepancies on said first API;
said software engine providing a third API to be accessed by said election authority facility and authorized third parties;
said third API used to provide election results on election count day;
said third API used to provide backup copies of essential files for the purposes of verification and, in the event of a catastrophic disruption of the voting facility, reconstruction elsewhere to resume the election process;
said third API used to support various monitoring and status reporting during and after an election.
providing a secondary engine operating on a second server, in tandem and independent from said first engine, while said primary engine has no dependency on information coming from the secondary engine;
said secondary engine performing duplicate ballot and hash processing;
receiving the encrypted SVNs from the main server along with corresponding unencrypted PVNs and ballot data for independent duplicate hashing, verification and
storage;
said primary engine operating on said first server:
assigning each voter a unique public voter number (PVN) and a unique secret voter number (SVN);
said public voter number (PVN) assigned to and identifiable by an individual voter;
said secret voter number (SVN) identifiable by said first engine;
said SVNs undergoing encryption utilize two asymmetric encryption key pairs wherein encrypted SVNs on election authority servers are different from the encrypted form of those same numbers stored in ballots;
storing encryption and decryption keys offsite on a separate key server and not providing them to the election authority or storing them on said engine, but allowing them to reside temporarily in said engine memory;
said primary engine on a first server performing all SVN encryption and decryption and providing encrypted SVNs to said election authority for subsequent assignment to voters;
allowing said voters to vote at intervals and times preceding election ballot count day;
providing to said end-user voting application a ballot record for each individual voter's collection of votes;
obtaining from said end-user voting application a completed ballot record for
each individual voter's collection of votes;
stamping said received ballot record with a time, date and facility indicator;
notifying said voter from said primary engine, of said received ballot
record by audio, text, email and/or postal mail;
assigning a status of unfrozen ballots, which are modifiable;
allowing voter inspection and interrogation of their ballot at any point during and for a period after the election, and cancellation of their ballot before it is frozen;
after a predetermined period (e.g., 72 hours) assigning a status of frozen to ballots, which become unmodifiable; and
tabulating frozen ballots.

2. The method of claim 1 wherein a plurality of engines exist on two or more separate servers, each operating in separate environments operating in tandem to verify mutual functionality.

3. The method of claim 1 wherein said first and second API data may be displayed on personal devices, including tablets, smart phones and computers, voting center devises, or a combination thereof;

4. The method of claim 3 wherein said first API may be utilized, bidirectionally via said primary engine, to both transmit data from voters to said voting authority and from said voting authority to said voters;

5. The method of claim 3 wherein said received data may consist of voter identifying information, vote identifying information, votes, or a combination thereof, and said transmitted data may consist of PVNs, notification of received votes, recorded votes, deleted votes, reports, statistics and vote identifying information.

6. The method of claim 2 wherein said third API may be used by an auditing entity to query said first, second, or a plurality of engines to determine discrepancies between and among engines.

7. The method of claim 1 wherein further comprising:
assigning each received ballot a unique number, supplemented with their encrypted SVN, hash totaled and stored in a queue designated as unfrozen;
placing hash values of unfrozen ballots in a separate file along with their ballot numbers; allowing voters to cancel (delete) their ballots from the unfrozen ballot queue;
after a pre-specified period (e.g., 72 hours) moving unfrozen ballots to a frozen ballot file:
after ballots have been added to the frozen ballot file, creating a batch record in a separate batch file, consisting of a unique batch number, a list of all ballot numbers in the batch and the hash value of all of the listed ballot content;
after batch records have been added to the batch file, creating a batch group record stored in a separate batch group file, consisting of a unique batch group number, a level number of one, a list of the batch records in the group and the hash value of all of the listed batch records;
after a batch group numbers have been created, another batch group record is created referring to batch group records (instead of batch records), and assigned a level number one greater than the level of the listed groups, in ascending hierarchical order;
continuously maintaining a top level hash value as batches are accumulated and grouped; specifically leaving ballots unencrypted except for their SVNs.

8. The method of claim 6 wherein, once a discrepancy or discrepancies are identified, those discrepancies may then be reported to or queried by a voting authority, an auditing authority, the public or a combination thereof.

9. The method of claim 1 wherein at specified or random intervals, an inspector program may be uploaded to said primary engine using a dynamic algorithm to modify its own hash values after startup and report to the offsite server its findings and its own recomputed hash value.

10. The method of claim 2 wherein each engine on each server may conduct security measures comprising:
periodically offloading each ballot file to a separate backup repository which may retain all backups until well after the election;
zeroing all unused memory;
recomputing the hash values of the operating system and the application program executable code at random intervals to verify consistency between servers;
recomputing, at random intervals or set intervals, all ballot hash values; and uploading an inspection program, hosted by said engine, from a remote server to examine engine memory, dynamically modify said programs memory, reporting audit results, recomputing hash values, or a combination thereof.

11. The method of claim 1 wherein said engine re-encrypts all SVN's
and all ballot hash values and sends the resultant ballot file and the batch total file to a list of independent destinations for verification.

12. The method of claim 1 wherein multiple state level ADEs collaborate via the Internet (or another networking facility) to accumulate state level totals for the purpose of reporting national election results.
